(19) United States
(12) Patent Application Publication
(10) Pub. No.: US 2017/0162171 A1
(43) Pub. Date: Jun. 8, 2017

(54) DISPLAY APPARATUS AND CONTROL METHOD THEREOF

(71) Applicant: SAMSUNG ELECTRONICS CO., LTD., Suwon-si (KR)

(72) Inventor: Eun-nim CHO, Suwon-si (KR)

(73) Assignee: SAMSUNG ELECTRONICS CO., LTD., Suwon-si (KR)

(21) Appl. No.: 15/367,328

(22) Filed: Dec. 2, 2016

(30) Foreign Application Priority Data
Dec. 2, 2015 (KR) 10-2015-0172302

(51) Int. Cl. G09G 5/02; G06F 1/16; G09G 5/38

(52) U.S. Cl. CPC G09G 5/02; G09G 5/38; G06F 1/1652

(57) ABSTRACT

Disclosed is a display apparatus including: a display configured to include a screen flexible to have a predetermined curvature; a receiver configured to receive an image signal; a signal processor configured to process the received image signal; and a controller configured to, if the received image signal has an aspect ratio different from a ratio of width to height of the screen, control the display to display a first image based on the image signal on a first area of the screen and a second image having image effects of attributes varied depending on a curvature of a second area on the second area around the first area.

### CROSS-REFERENCE TO RELATED APPLICATION

This application claims priority from Korean Patent Application No. 10-2015-0172302, filed on Dec. 2, 2015 in the Korean Intellectual Property Office, the disclosure of which is incorporated herein by reference.

### BACKGROUND

Field

Apparatuses and methods consistent with exemplary embodiments relate to a display apparatus and a control method thereof, and more particularly to a display apparatus improved in displaying a second image displayed on a second area where a first image is not displayed, and a control method thereof.

Description of the Related Art

A display of a display apparatus for displaying an image may have a flat structure and a curved structure. The curved structure is classified into a rigid curved structure, the curvature of which is rigidly maintained, and a flexible curved structure, the curvature and bending form of which are variable.

The display with such various structures includes a screen having a predetermined ratio of width to height. If the display displays an image having an aspect ratio different from the predetermined ratio of width to height of the display, an area of the display includes an area where the image is displayed (hereinafter, referred to as a “first image”) and an area where the image is not displayed (hereinafter, referred to as a “second area”). The second area is irrelevant to an image displayed on the first image, and thus decreases reality and immersion in the image.

### SUMMARY

According to an aspect of an exemplary embodiment, there is provided a display apparatus including: a display configured to include a screen flexible to have a predetermined curvature; a receiver configured to receive an image signal; a signal processor configured to process the received image signal; and a controller configured to, if the received image signal has an aspect ratio different from a ratio of width to height of the screen, control the display to display a first image based on the image signal on a first area of the screen and a second image having image effects of attributes varied depending on a curvature of a second area on the second area around the first area.

The second image may include an image which is displayed reflecting at least one of a color, brightness, contrast, a tone and a scale ratio of the first image.

The image effects may include at least one of a gradation, blurring and scaling.

The gradation may include a gradation of a color selected among a plurality of colors contained in the first image.

The color may be selected from a part of the first area adjacent to the second area.

The color may be selected from each of a plurality of parts of the first image, and the image effects may be differently applied in accordance with use frequencies of the plurality of selected colors.

The first image may include a repetitive pattern, and the image effects may correspond to the pattern of the first image.

The pattern of the first image may have an orientation, and the image effects may be oriented corresponding to the orientation of the first image.

According to an aspect of an exemplary embodiment, there is provided a method of controlling a display apparatus including a display having a screen flexible to have a predetermined curvature, the method including: receiving an image signal; processing the received image signal; if the received image signal has an aspect ratio different from a ratio of width to height of the screen, displaying a first image based on the image signal on a first area of the screen; and displaying a second image having image effects of attributes varied depending on a curvature of a second area on the second area around the first area.

The second image may include an image which is displayed reflecting at least one of a color, brightness, contrast, a tone and a scale ratio of the first image.

The image effects may include at least one of a gradation, blurring and scaling.

The gradation may include a gradation of a color selected among a plurality of colors contained in the first image.

The color may be selected from a part of the first area adjacent to the second area.

The color may be selected from each of a plurality of parts of the first image, and the image effects may be differently applied in accordance with use frequencies of the plurality of selected colors.

The first image may include a repetitive pattern, and the image effects may correspond to the pattern of the first image.

The pattern of the first image may have an orientation, and the image effects may be oriented corresponding to the orientation of the first image.

Thus, it is possible to more increase reality and immersion in the first image.

### BRIEF DESCRIPTION OF THE DRAWINGS

The above and/or other aspects will become apparent and more readily appreciated from the following description of exemplary embodiments, taken in conjunction with the accompanying drawings, in which:

FIG. 1 is a perspective view of a display apparatus according to an exemplary embodiment;

FIG. 2 is a block diagram of the display apparatus of FIG. 1;

FIG. 3 illustrates an example of the display apparatus of FIG. 1;

FIG. 4 is a perspective view of the display apparatus of FIG. 1;

FIG. 5 is a flowchart of controlling the display apparatus of FIG. 4;

FIG. 6 to FIG. 8 illustrate examples of the display apparatus of FIG. 4;

FIG. 9 is a plan view of the display apparatus of FIG. 4;

FIG. 10 to FIG. 13 illustrate examples of the display apparatus of FIG. 4;

FIG. 14 to FIG. 18 illustrate examples of the display apparatus of FIG. 4; and

FIG. 19 is an example of the display apparatus of FIG. 4.

### DETAILED DESCRIPTION OF EXEMPLARY EMBODIMENTS

Below, exemplary embodiments will be described with reference to accompanying drawings. The following exemplary embodiments will describe only elements directly related to the present inventive concept, and description of the other elements will be omitted. However, it will be appreciated that the elements, the descriptions of which are omitted, are not unnecessary to realize the apparatus or system according to the exemplary embodiments.

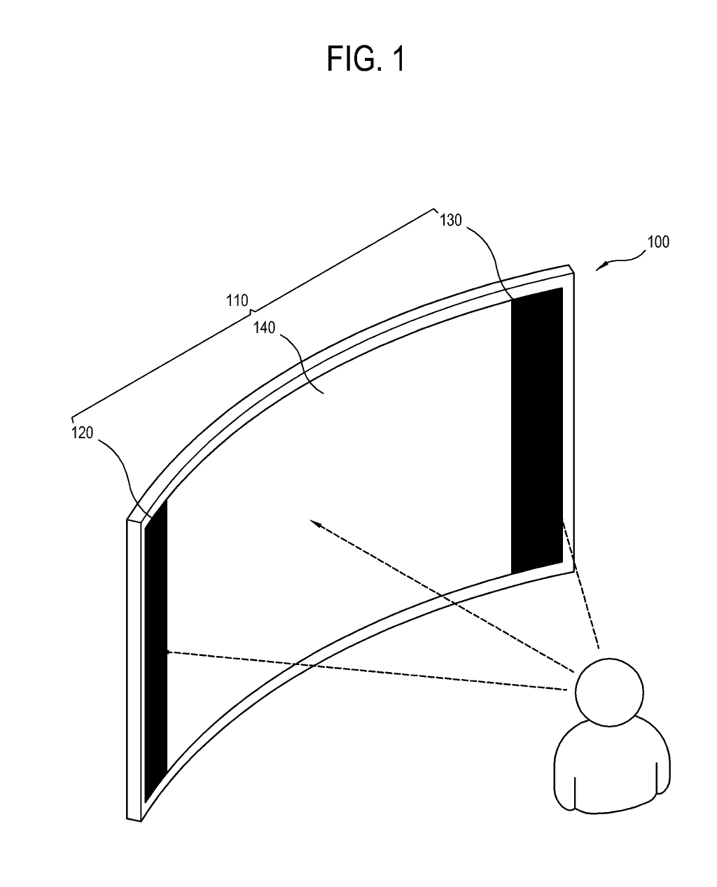

FIG. 1 is a perspective view of a display apparatus 100 according to an exemplary embodiment. As shown in FIG. 1, the display apparatus 100 in this exemplary embodiment may be achieved by a curved display apparatus in the form of bending a rectangular plate to have a predetermined curvature. As compared with a flat structure, the display apparatus 100 has left and right edges bent toward a front where a user is positioned. This bending state of the display apparatus 100 may be rigidly maintained. In addition, the display apparatus 100 may be variously achieved. For example, the left and right edges of the display apparatus 100 may be bent to be far away from the front, or upper and lower edges of the display apparatus 100 may be bent frontward or backward. In addition, the display apparatus 100 may be achieved by a bendable display apparatus, the bending state of which is adjustable by an external force or a driving force of a driving device provided in the display apparatus 100.

The display apparatus 100 includes a display 110 having a screen on which an image is displayed. Here, the screen of the display 110 is also curved to have a predetermined curvature. Further, the display 110 may have a wide screen, width of which is greater than length. If an image is displayed on such a curved wide screen, reality and immersion in an image are improved.

In a particular case of displaying an image having an aspect ratio different from a ratio of width to height of the screen, the display 110 in this embodiment has a first area 140 for displaying a first image corresponding to the corresponding image, and second areas 120 and 130 placed around the first image. At this time, the second areas 120 and 130 may display not a gray tone color but a second image having image effects of which attributes are varied depending on the predetermined curvature of the second areas 120 and 130. Thus, the second image more improves the reality and immersion in the first image.

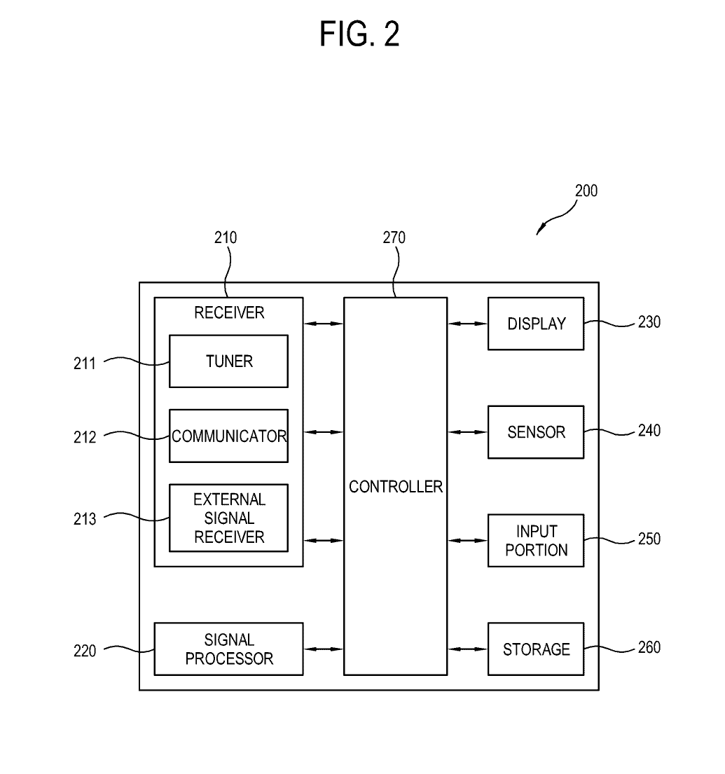

Below, elements of the display apparatus 100 of FIG. 1 will be described in more detail with reference to FIG. 2.

FIG. 2 is a block diagram of the display apparatus 100 of FIG. 1. The display apparatus 200 of FIG. 2 corresponds to the display apparatus 100 of FIG. 1, and thus repetitive descriptions will be avoided as necessary.

The display apparatus 200 of FIG. 2 includes a receiver 210 for receiving an image signal, a signal processor 220 for processing the image signal received in the receiver 210 in accordance with preset processes, a display 230 for displaying an image based on the image signal processed in the signal processor 220, a sensor 240 for sensing a curvature of the display 230, an input portion 250 for receiving a user's input, a storage 260 for storing data, and a controller 270 for controlling general operations of the display apparatus 200 such as the signal processor 220.

The receiver 210 includes a tuner 211 for receiving broadcast signal from various sources, a communicator 212 for performing communication to exchange data/signal with the exterior, and an external signal receiver 213 for receiving video and audio data from devices respectively connected to the display apparatus 200.

Specifically, the tuner 211 may receive broadcast signals from various sources such as terrestrial broadcasting, cable broadcasting, satellite broadcasting, Internet broadcasting, etc. Further, the tuner 211 may receive broadcast signals from sources such as analog broadcasting, digital broadcasting, etc. The tuner 211 may receive video, audio and data at a frequency band corresponding to a channel number of each source. The tuner 211 may be achieved in the form of all-in-one together with the display apparatus 200 or may be achieved in the form of a separate device such as a set-top box electrically connected to the display apparatus 200.

The communicator 212 transmits and receives data locally or through a network under control of the controller 270 so that the display apparatus 200 can interactively communicate with the exterior. For example, the communicator 212 may use at least one of wired Ethernet, wireless local area network (Wi-Fi), Bluetooth, near field communication or the like short-range communication, etc. in accordance with performance and structures of the display apparatus 200. The communicator 212 may be provided as a built-in element of the display apparatus 200, or the whole or part thereof may be additionally installed in the form of add-on or dongle to the display apparatus 200.

The external signal receiver 213 can receive video and audio data from the devices respectively connected to the display apparatus 200 under control of the controller 270. For example, the external signal receiver 213 may receive video and audio data based on various formats such as composite/component video, super video, SCART, high definition multimedia interface (HDMI), DisplayPort, unified display interface (UDI), or wireless HD, etc.

The signal processor 220 applies various processes to the data/signal received in at least one of the tuner 211, the communicator 212 and the external signal receiver 213 under control of the controller 270. For example, if video data is received, the signal processor 220 applies video processing processes to the video data, and then outputs the processed video data to the display 230 so that the display 230 can display an image based on the video data.

Further, if a broadcast signal is received, the signal processor 220 extracts video, audio and additional data from a broadcast signal tuned to a certain channel under control of the controller 270, and adjusts an aspect ratio of the extracted image to be displayed on the display 230. For instance, if the display 230 supports an aspect ratio of 21:9 but an image signal having an aspect ratio of 16:9 is received, the signal processor 220 may convert an image corresponding to the received image signal to be fully displayed on the screen of 21:9. On the contrary to this, an image having an aspect ratio of 21:9 may be converted to have an aspect ratio of 16:9.

There are no limits to the kinds of image processing processes performed by the signal processor 220. For example, the image processing processes may include decoding corresponding to a video format of video data, de-interlacing for converting an interlaced type of video data into a progressive type, scaling for adjusting video data to have a preset resolution, noise reduction for improving image quality, detail enhancement, frame refresh rate conversion, etc.

The signal processor 220 can perform various processes in accordance with the kinds and properties of data, and therefore the processes performed in the signal processor 220 are not limited to the image processing processes. The signal processor 220 may be provided in the form of a system-on-chip (SOC) as it is integrated into the controller 270, but not limited thereto. As necessary, the signal processor 220 may be coupled to another functional element or may be provided independently.

The display 230 displays an image based on the image signal/video data processed by the signal processor 220 under control of the controller 270. The display 230 may be variously achieved without limitation. However, the display 230 may have a curved wide screen as described above. As necessary, the display 230 may display a user interface (UI) for setting whether to display the second image on the second areas 120 and 130, whether to display the mage effects applicable to the second image, the kind of image effects, an applicable level of image effects, etc. in accordance with a user's input.

The input portion 250 receives various preset control command or information in accordance with a user's manipulation or input. For example, the input portion 250 may receive a user's input about whether to display the second image on the second areas 120 and 130, the kind of attributes the second image has, and the applicable level of attributes. If the input portion 250 receives a user's input, the controller 270 may control the elements to perform preset operations in response to the user's input received in the input portion 250.

The input portion 250 may be achieved in various forms to generate input information from a user. For example, the input portion 250 may be at least one of a key/button provided in the outside of the display apparatus 200, a microphone for receiving a user's voice, a camera for taking a picture of a user, and a touch screen integrated into the display 230. Further, the input portion 250 may be a remote controller, a smart phone, a tablet computer, a notebook computer, and the like that is provided separately from the display apparatus 200 and communicates with the communicator 212.

The storage 260 stores various pieces of data under control of the controller 270. The storage 260 may be achieved by a flash memory, a hard disc drive and the like nonvolatile memory to preserve data regardless of system power on/off. The storage 260 is accessed by the signal processor 220 or the controller 270 to read, write, edit, delete or update data.

The sensor 240 can sense the curvature of the display 230. The sensor 240 is flexible and thus senses resistance that varies in proportion to its own curved degree.

The controller 270 is achieved by a central processing unit (CPU) or processor, and controls operations of the display apparatus 200 in response to a certain event. For example, the controller 270 controls the signal processor 220 to process video data of certain content received in at least one of the tuner 211, the communicator 212 and the external signal receiver 213 and controls the display 230 to display an image based on the processed video data. Further, the controller 270 controls the elements such as the signal processor 220 to perform operations previously set corresponding to an event of a user's input if the event occurs in the input portion 250.

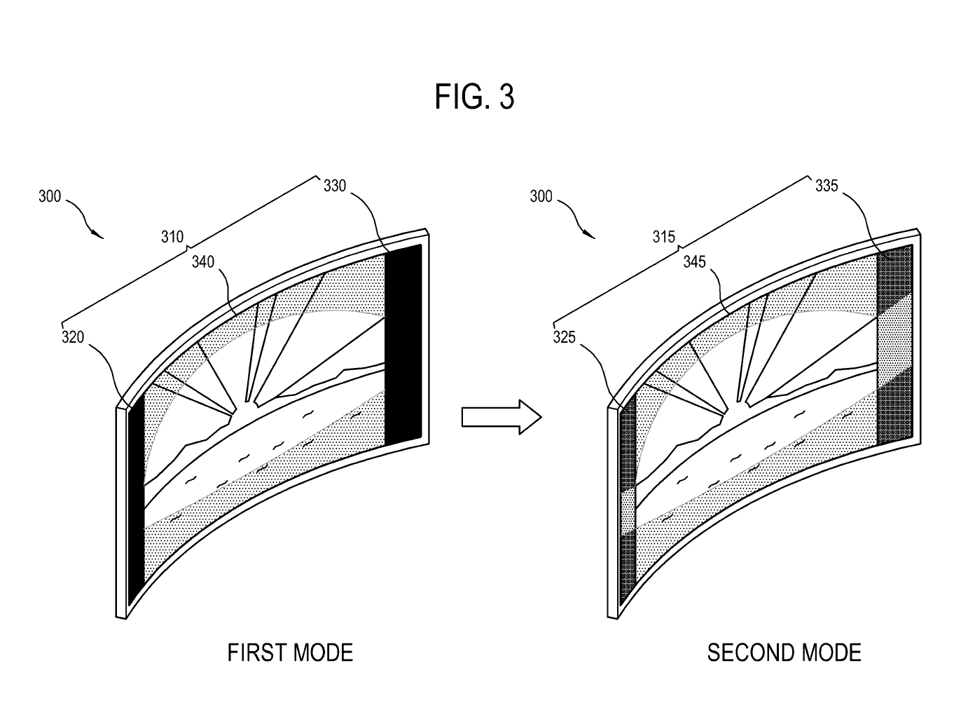

FIG. 3 illustrates an example of the display apparatus 100 of FIG. 1. The display apparatus 300 of FIG. 3 is equivalent to the display apparatus 100 of FIG. 1, and thus repetitive descriptions will be avoided. In FIG. 3, the display apparatus 300 has a display 310, 315 having a wide screen of which width is greater than height. For example, the display 310, 315 may have an aspect ratio of 21:9, and display not only an image having the same aspect ratio of 21:9 as that of the display 310, 315 but also an image having an aspect ratio of 16:9 different from that of the display 310, 315.

The display apparatus 300 may operate in a first mode or in a second mode in accordance with a user's input in the input portion 250. As necessary, the controller 270 may control the display 310, 315 to display a UI for allowing a user to select the first mode or the second mode, and switch between the first mode and the second mode in accordance with a user's input.

If an image different in the aspect ratio from the display 310 is input in the first mode, the display apparatus 300 displays the input image on a first area 340. For example, if the display 310 has an aspect ratio of 21:9 and an image having an aspect ratio of 16:9 is input, the image of 16:9 is displayed as the first image on the first area 340 corresponding to 16:9 and an image having a gray tone color is displayed on the second areas 320 and 330. Here, the gray tone color has a value of 40IRE since it can prevent the display 310 from being deteriorated by high temperature. Alternatively, the second areas 320 and 330 may display an image with other colors than the gray tone color.

The first area 340 is an area corresponding to an input image of 16:9, and may be placed randomly as well as at the center of the display 310. As necessary, if an input image is different in resolution from the display 310, an image corresponding to the resolution of the input image may be displayed on not only the center area but also other random areas.

If the display apparatus 300 switches over to the second mode in response to a user′ input in the input portion 250, the controller 270 displays a second image, which has image effects having attributes varied depending on a curvature of the second areas 325 and 335, on the second areas 325 and 335 while displaying the first image on the first area 345. Here, the second image reflects the attributes such as color, brightness, contrast, tone, resolution, scale ratio, etc. of the first image. That is, the second image, which has image effects having attributes varied depending on a curvature of the second areas 325 and 335, is displayed on the second areas 325 and 335 by reflecting the attributes of the first image. Therefore, a user may feel as if the first image is extended and fully displayed on the display 315.

For example, if the first image contains sunlight radiating from the center of the screen outward, the first mode makes the first area 340 to display only the first image on and fills the second areas 320 and 330 with the second image having only the gray tone color.

On the other hand, the second mode makes the second areas 325 and 335 to display the second image reflecting the color, brightness, contrast, tone and radiating pattern of the sunlight contained in the first image as if the sunlight spreads throughout the screen of the display 315.

If the second areas 325 and 335 are bent or curved to have a predetermined curvature in the second mode, the color of the sunlight displayed on the second areas 325 and 335 may be varied or have gradation in accordance with the curvature. Here, the gradation refers to image effects for giving a rhythmic sense to an image through gradual change in color or brightness of the image. Therefore, gentle gradation indicates small changes in color or brightness, but rapid gradation indicates large changes in color or brightness.

For example, if the curvature of the second areas 325 and 335 is low, the gradation of color is more segmented to make the gentle gradation. On the other hand, if the curvature is high, the gradation of color is simplified to make the rapid gradation. However, a relationship between the curvature and the gradation may be properly changed in accordance with circumstances. Further, not only the gradation but also the brightness or resolution of the second image may be weighted to blur, or the scale ratio may be adjusted to display the scaling-processed second image on the second areas 325 and 335.

Thus, if the attributes of the second image are varied depending on the curvature of the second areas 325 and 335 in the second mode, it is possible to maximize reality and immersion with respect to the first image.

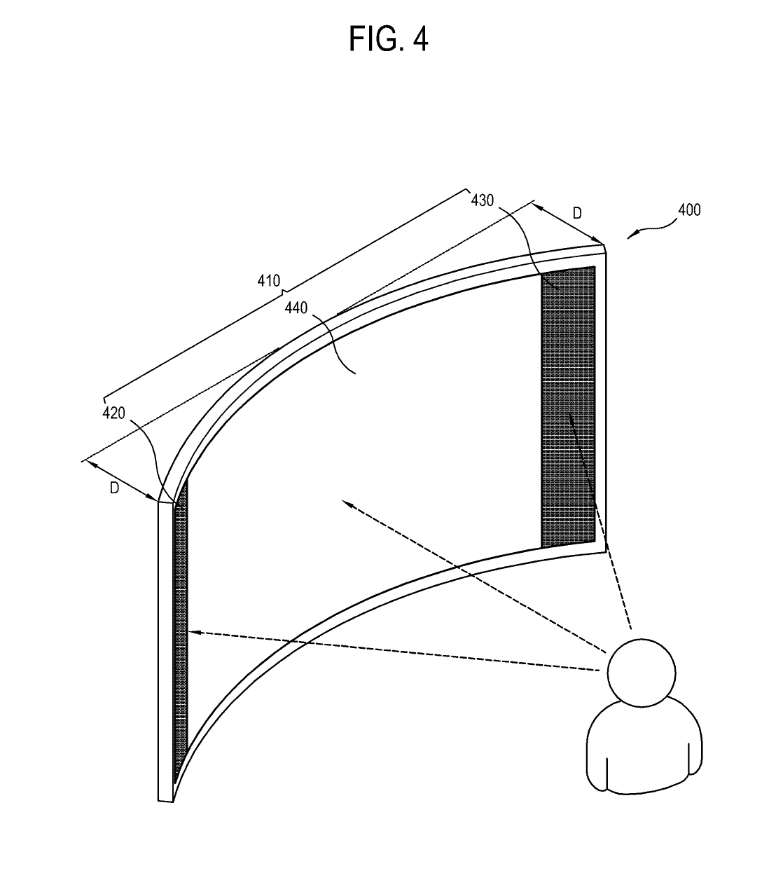

FIG. 4 is a perspective view of the display apparatus 100 of FIG. 1. The display apparatus 400 of FIG. 4 is equivalent to the display apparatus 100 of FIG. 1, and thus repetitive descriptions will be avoided. The sensor 240 of the display apparatus 400 can sense a bending angle D corresponding to the curvature of the display 410, and the controller 270 can calculate the curvature of the second area 420 and 430 based on the sensed bending angle D. The controller 270 may change the attributes of the second image to be displayed on the second areas 420 and 430 in accordance with the calculated curvature.

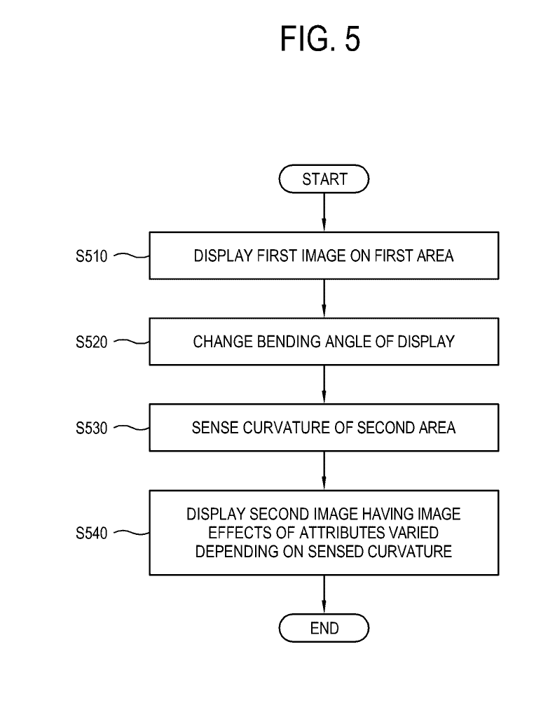

FIG. 5 is a flowchart of controlling the display apparatus of FIG. 4. Referring to FIG. 5, the first image different in the aspect ratio from the display 410 of the display apparatus 400 of FIG. 4 is displayed on the first area 440 (S510). At this time, if the bending angle D of the display 410 is changed (S520), the display apparatus 400 senses the curvature based on the changed bending angle D (S530), and displays the second image having the image effects having attributes varied depending on the sensed curvature on the second areas 420 and 430 (S540).

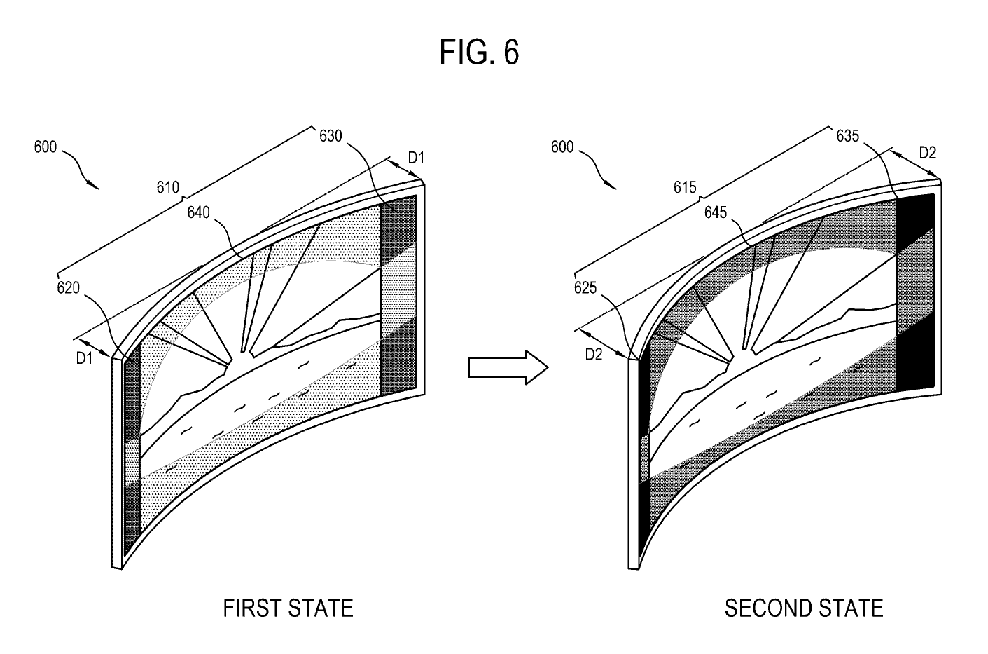

FIG. 6 to FIG. 8 illustrate examples of the display apparatus 400 of FIG. 4. In FIG. 6 to FIG. 8, display apparatuses 600, 700 and 800 are each equivalent to the display apparatus 400 of FIG. 4, and thus repetitive descriptions will be avoided.

First, referring to FIG. 6, in a first state, a display 610 of a display apparatus 600 has first curvature based on a first bending angle D1, the first image is displayed on a first area 640, and the second image having the image effects corresponding to the first curvature is displayed on the second areas 620 and 630. In FIG. 6, it is assumed that the attributes varied depending on the curvature is the color of the second image, and the image effects corresponding to change in color is the gradation. Therefore, in the first state, the color of the second image is changed corresponding to the first curvature based on the first bending angle D1, and the gradation of the changed color is reflected in the second image.

In a second state, the second bending angle D2 of the display 615 is greater than the first bending angle D1. Since the second curvature is greater than the first curvature, the gradation of the second image in the second state is rapider than the gradation of the first state and displayed on the second areas 625 and 635. For example, the gradation in the second state may be more simplified than the gradation in the first state, thereby increasing difference in color. As necessary, the display apparatus 600 may use blurring or scaling as the image effects besides the gradation, and thus change a blurring effect or a scaling ratio in accordance with increase/decrease in the curvature.

Thus, the display apparatus 600 changes the image effects to be reflected in the second image in accordance with increase/decrease of the curvature of the display 610, 615, thereby maximizing the reality and immersion with respect to the first image.

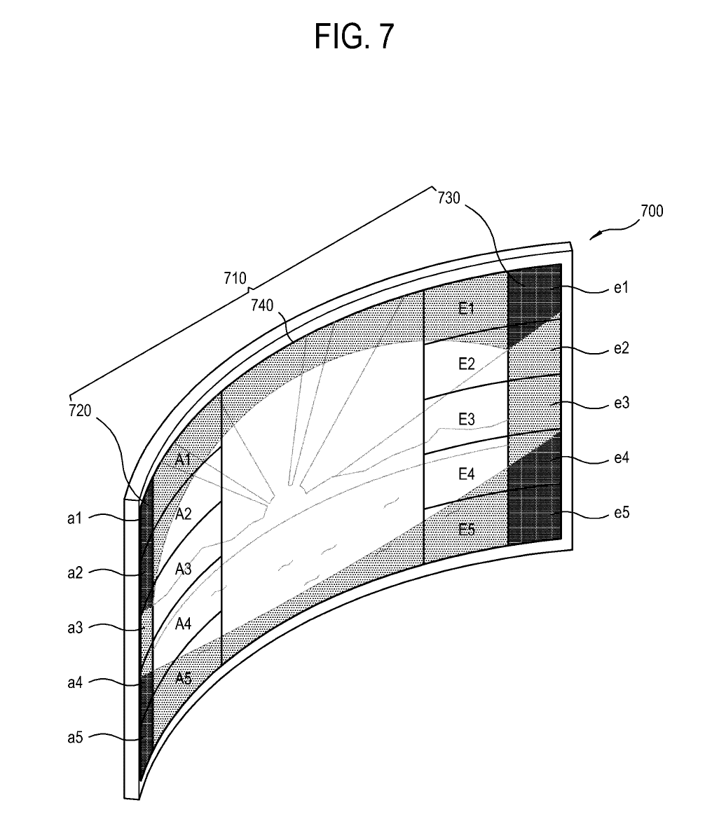

Referring to FIG. 7, if an image different in an aspect ratio from a display 710 is input, the display apparatus 700 divides a first area 740 and second areas 720 and 730 of the display 710 into a predetermined number of areas or grids. The display apparatus 700 selects areas A1˜A5 and E1˜E5 of the first area 740, which are adjacent to the second areas a1˜a5 and e1˜e5, and reflects a color, which is used more frequently than a predetermined value among colors used in the first image displayed on the selected areas, in the second areas a1˜a5 and e1˜e5. Here, the first image includes color components of each pixel, and the color components may be represented by combination of red (R), green (G) and blue (B). In this exemplary embodiment, an RGB model is applied, but not limited thereto.

For example, when the display apparatus 700 selects a color for the second image to be displayed on the area a1 among the areas of the second areas 720 and 730, the area A1 adjacent to the area a1 is selected among the areas of the first area 740, and a color used more frequently than a predetermined value is selected among the colors of the pixels included in the selected area A1 and reflected in the area a1. However, the color to be reflected in the area a1 is not selected from only the first image adjacent to the area a1. Alternatively, a color of a boundary point or boundary area between the first area and the second area may be selected and reflected in the area a1. As necessary, a plurality of colors may be respectively selected from a plurality of parts in the first area. In this case, the image effects may be applied differently in accordance with use frequencies of the plurality of selected colors.

Since the sensor 240 can sense the curvature of the second area 720 and 730, the display apparatus 700 may make the selected colors be changed in accordance with the curvature of the second areas 720 and 730 and displayed on the second areas 720 and 730.

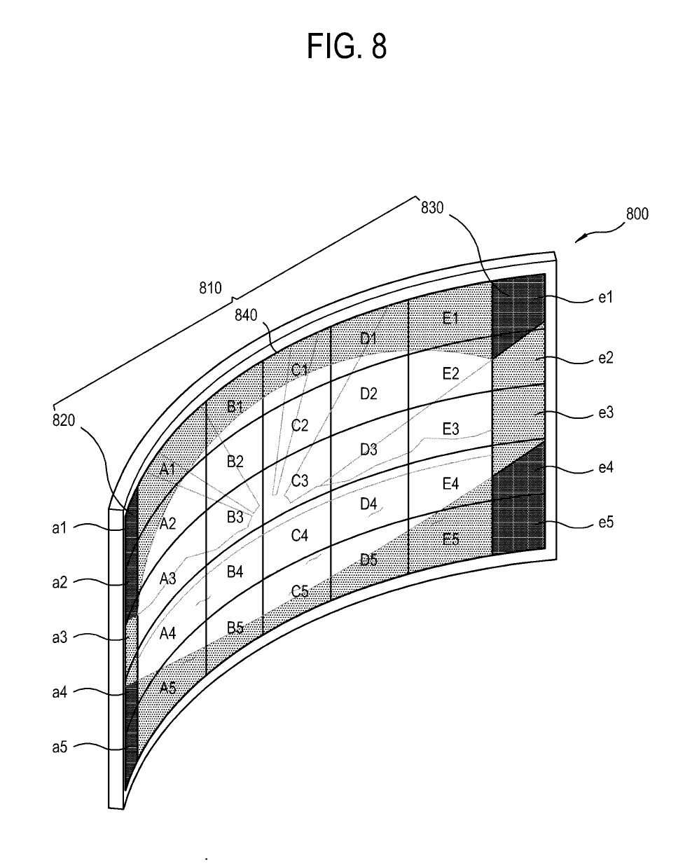

Referring to FIG. 8, a controller 270 of a display apparatus 800 divides a first area 840 and second areas 820 and 830 of a display 810 into predetermined areas or grids. The first area 840 may be divided into areas A1˜E5, and the second areas 820 and 830 may be respectively divided into areas a1˜a5 and e1˜e5.

The controller 270 of the display apparatus 800 selects a predetermined area among the areas of the first image, and selects a predetermined color to be reflected in the second image among the colors of the selected area. For example, the controller 270 selects areas A1, A2, B1 and B2 adjacent to a target area a1 among the areas of the first area 840, and selects a predetermined color from each area A1, A2, B1, B2. The controller 270 may make the selected colors be weighted in accordance with distances between the target area a1 and the areas A1, A2, B1 and B2. The controller 270 may assign a weight of 70% to the color selected from the area A1 the most adjacent to the area a1, a weight of 60% to the color selected from the area A2, a weight of 50% to the color selected from the area B1, and a weight of 30% to the color selected from the area B2. However, the method of selecting a predetermined area adjacent to the target area or assigning the weight to the selected color is not limited to the foregoing description.

The controller 270 may change the color weighted in accordance with the curvature sensed by the sensor 240, and display the second image having the gradation of the changed color on the second areas 820 and 830.

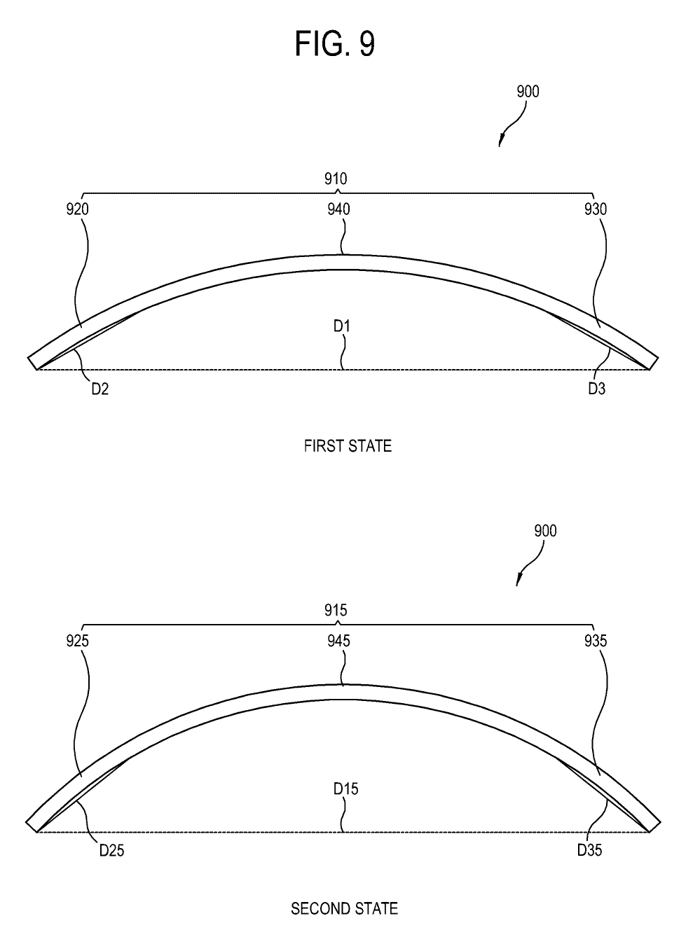

FIG. 9 is a plan view of the display apparatus 400 of FIG. 4. Since a display apparatus 900 of FIG. 9 corresponds to the display apparatus 400 of FIG. 4, repetitive descriptions will be avoided.

Referring to FIG. 9, the second areas 920 and 930 of the display 910 are bent to have a first curvature in the first state, and the second areas 925 and 935 of the display 915 are bent to have a second curvature in the second state. Here, it is assumed that the second curvature is greater than the first curvature. If an image signal different in aspect ratio from the display 910 is input in the first state, the controller 270 of the display apparatus 900 controls the first area 940 having the same aspect ratio as the image signal to display a first image based on the image signal. Further, the second areas 920 and 930, on which the first image is not displayed, display a second image having image effects of attributes corresponding to the first curvature. Here, if the attributes of the second image is the color and the image effects of the attributes are the gradation, the controller 270 changes the color, which is selected in connection with the first image, in accordance with the first curvature, and displays the second image having the gradation of the changed color on the second areas 920 and 930.

Specifically, the controller 270 calculates the dimensions D2 and D3 of the second areas 920 and 930 with respect to the first curvature in accordance with the first curvature, and displays the second image having the gradation based on the calculated dimensions D2 and D3 on the second areas 920 and 930. Here, the dimensions with respect to the first curvature refer to areas D2 and D3 projected on a plane when the second areas 920 and 930 curved and bent to have the first curvature are projected on the plane. That is, if the dimension of the display 910 on the plane with respect to the first curvature is D1, the dimensions of the second areas 920 and 930 on the plane are D2 and D3.

In the second state, the controller 270 changes the selected color in accordance with the second curvature, and displays the second image having the gradation of the changed color on the second areas 925 and 935. Like the first state, the controller 270 calculates the dimensions D25 and D35 of the second areas 925 and 935 with respect to the second curvature, and displays the second image having the gradation based on the calculated dimensions D25 and D35 on the second areas 925 and 935.

In the first state, the dimensions D2 and D3 with respect to the curvature are relatively large, and therefore the controller 270 more segments the gradation of the color to get the gentle gradation. On the other hand, in the second state, the dimensions D25 and D35 with respect to the curvature are relatively small, and therefore the controller 270 simplifies the gradation of the color to get the rapid gradation. Thus, the gradation in the second state is rapider than the gradation in the first state.

To this end, information obtained by mapping the gradation of the color with the dimension of the curvature may be stored in the storage 260. For example, the storage 260 may store information obtained by mapping a gradation of 100 colors with the dimensions D2 and D3 with respect to the curvature in the first state, and information obtained by mapping a gradation of 50 colors with the dimensions D25 and D35 with respect to the curvature in the second state. Therefore, if the curvature of the second area is changed, the controller 270 may receive a gradation corresponding to the changed curvature from the storage 260 and apply image effects based on the received gradation to the second image.

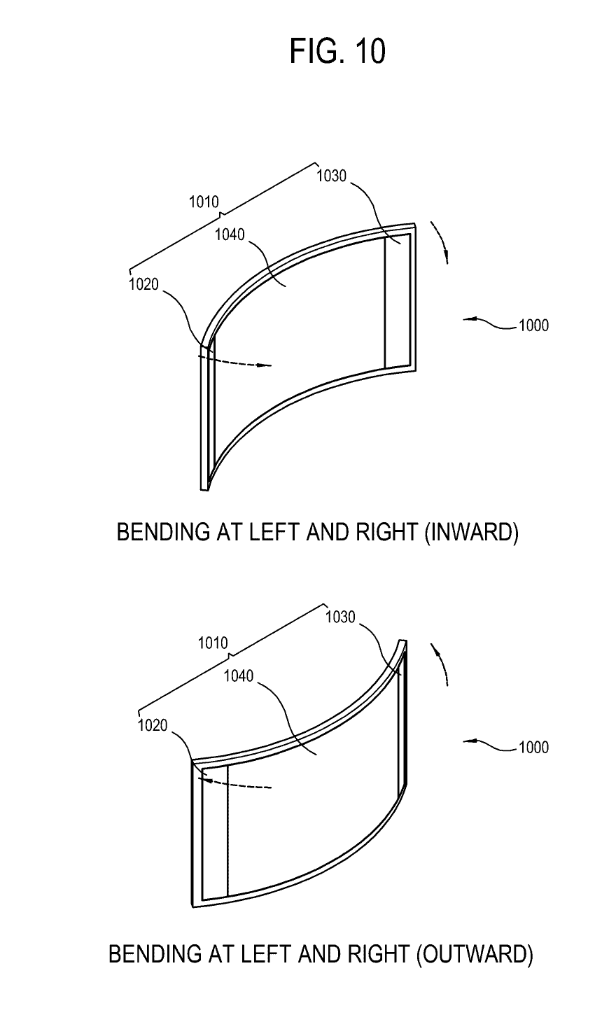

The curvature is caused by bending the display 910, 915. However, the left and right edges of the display 910, 915 do not have to be bent frontward. In this regard, embodiments will be described in detail with reference to FIG. 10 to FIG. 14.

FIG. 10 to FIG. 13 illustrate examples of the display apparatus of FIG. 4. Display apparatuses 1000, 1100, 1200 and 1300 of FIG. 10 to FIG. 14 are each equivalent to the display apparatus 400 of FIG. 4, and thus repetitive descriptions will be avoided. First, referring to FIG. 10, the display apparatus 1000 includes a display 1010 having a first area 1040 for displaying a first image, and second areas 1020 and 1030 for displaying a second image. The display 1010 has a wide screen of which width is greater than height.

The second areas 1020 and 1030 may be bent not only inward but also outward to have a predetermined curvature at the left and right edges of the display apparatus 1000. Even in the case of bending the left and right edges of the display apparatus 1000 outward, the second areas 1020 and 1030 may display a second image having image effects of attributes varied depending on the curvature of the second areas 1020 and 1030.

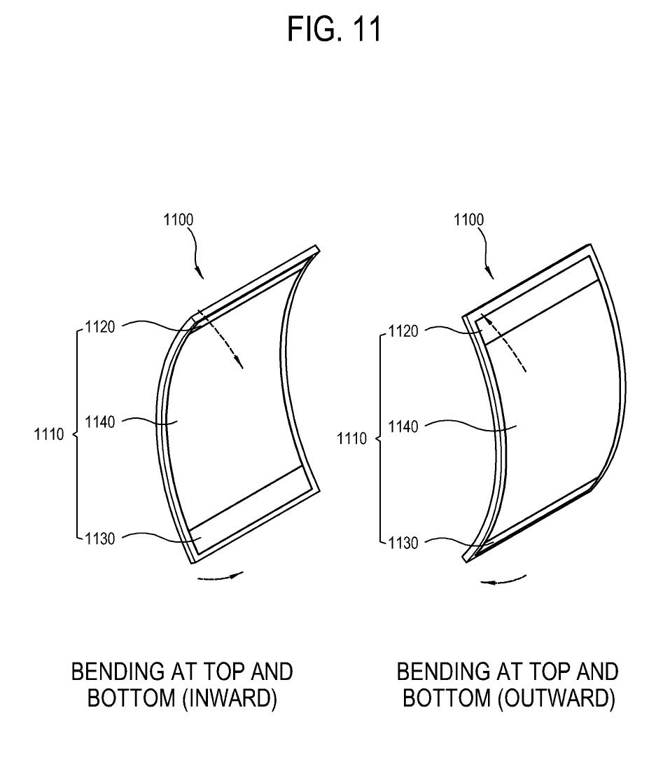

Referring to FIG. 11, the display apparatus 1100 includes a display 1110 having a wide screen of which height is greater than width. That is, the second areas 1120 and 1130 are placed in upper and lower sides of the display 1110. Second areas 1120 and 1130 of the display apparatus 100 may be bent not only inward but also outward. Even in the case of bending the display apparatus 1100 outward, the second areas 1120 and 1130 placed at the upper and lower sides of the display 1110 may display a second image having image effects of attributes varied depending on the curvature of the second areas 1120 and 1130.

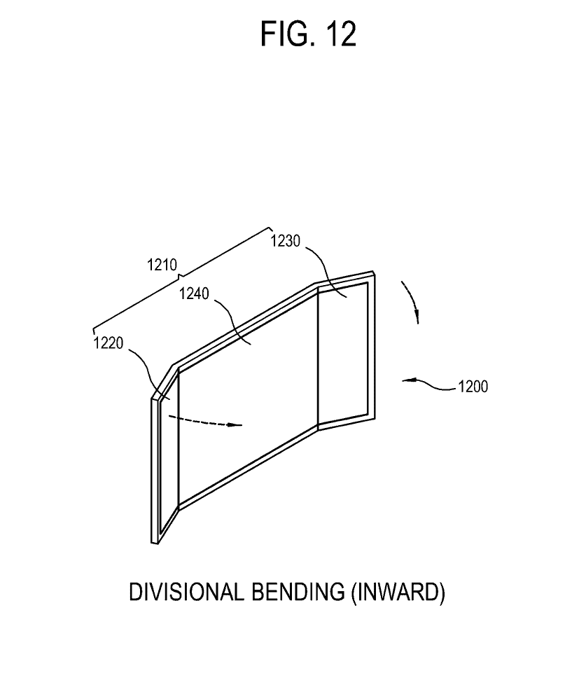

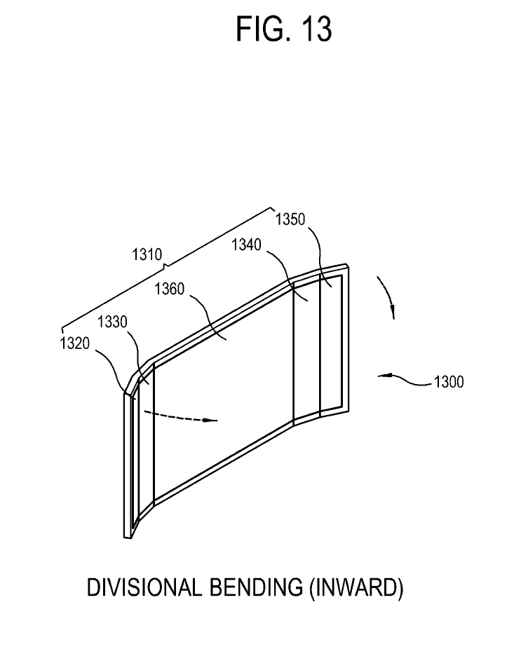

Referring to FIG. 12 to FIG. 13, display apparatuses 1200 and 1300 respectively include displays 1210 and 1310 having wide screens of which width is greater than height. Second areas 1220, 1230, 1320, 1330, 1340 and 1350 of the displays 1210 and 1310 may be divisionally bent forward or backward with respect to the display apparatuses 1200 and 1300. The divisional bending refers to that the display 1210, 1310 is divided into a plurality of sections and then the divisional sections are bent. In FIG. 12, the display 1210 of the display apparatus 1200 is divided into three sections and then bent. That is, the display 1210 is divided into two sections corresponding to the second areas 1220 and 1230 and one section corresponding to the first area 1240, and the second areas 1220 and 1230 are bent forward or backward with respect to the display apparatus 1200. In this case, the second areas 1220 and 1230 may display a second image having image effects of attributes varied depending on the bending angles of the second areas 1220 and 1230.

In FIG. 13, the display 1310 of the display apparatus 1300 is divided into five sections and then bent. That is, the display 1310 is divided into four sections corresponding to the second area 1320, 1330, 1340 and 1350 and one section corresponding to the first area 1360, and the second areas 1320, 1330, 1340 and 1350 are bent forward or backward with respect to the display apparatus 1300. In this case, a color of a first image to be displayed on the first area 1360 may be selected, and a second image having image effects corresponding to the selected color may be displayed on the second areas 1320, 1330, 1340 and 1350.

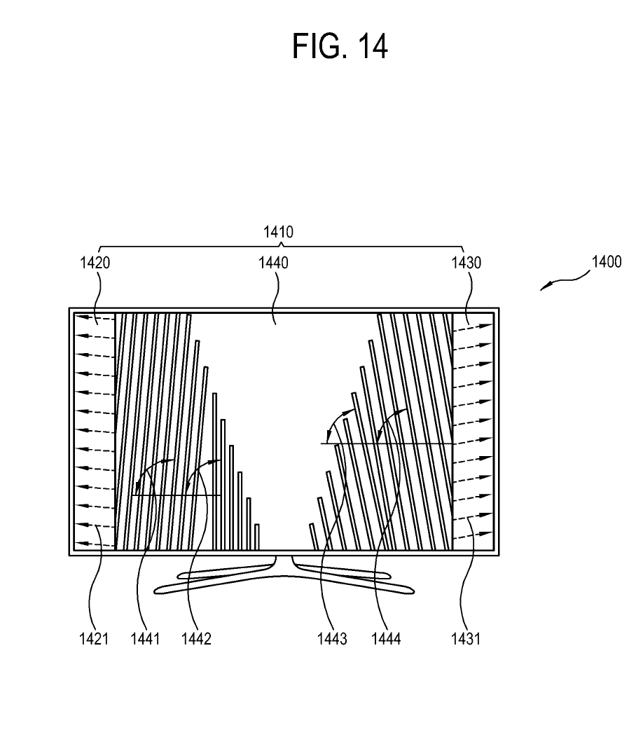

FIG. 14 to FIG. 18 illustrate examples of the display apparatus 400 of FIG. 4. Display apparatuses 1400, 1500, 1600, 1700 and 1800 shown in FIG. 14 to FIG. 18 are each equivalent to the display apparatus 400 of FIG. 4, and thus repetitive descriptions will be avoided.

Referring to FIG. 14, the display apparatus 1400 extracts a pattern included in a first image and an orientation of the pattern, and selects a color of the object. If the curvature of the second areas 1420 and 1430 is sensed, a second image having image effects of a pattern, an orientation of the pattern and the color, which are varied depending on the sensed curvature of the second area, is displayed on the second areas 1420 and 1430. Here, if there is a plurality of patterns, an average gradient of the patterns is calculated and the calculated average gradient is determined as the orientation of the pattern. For example, to determine a left second image to be displayed on the left second area 1420, the controller 270 of the display apparatus 1400 extracts a pattern of a plurality of objects adjacent to the left second area 1420 among the plurality of objects contained in the first image and the gradients 1441 and 1442 of the patterns, and selects the color of the object. The controller 270 calculates an average gradient of the patterns from the plurality of objects, and displays a pattern 1421 perpendicular to the calculated average gradient on the second area 1420. The controller 270 may apply a gradation of the selected color to the pattern displayed on the second area 1420. As the curvature of the left second area 1420 becomes higher, the gradient of the pattern displayed on the left second area 1420 may be changed or the gradation may be rapidly displayed.

Further, to determine a right second image to be displayed on the right second area 1430, the controller 270 extracts a pattern adjacent to the right second area 1430 among the plurality of objects contained in the first image and the gradients 1443 and 1444 of the patterns, and selects the color of the object. The controller 270 calculates an average gradient of the patterns, and displays a pattern 1431 perpendicular to the calculated average gradient. The controller 270 may apply a gradation of the selected color to the displayed pattern. As the curvature of the right second area 1430 becomes higher, the gradient of the pattern displayed on the right second area 1430 may be changed or the gradation may be rapidly displayed.

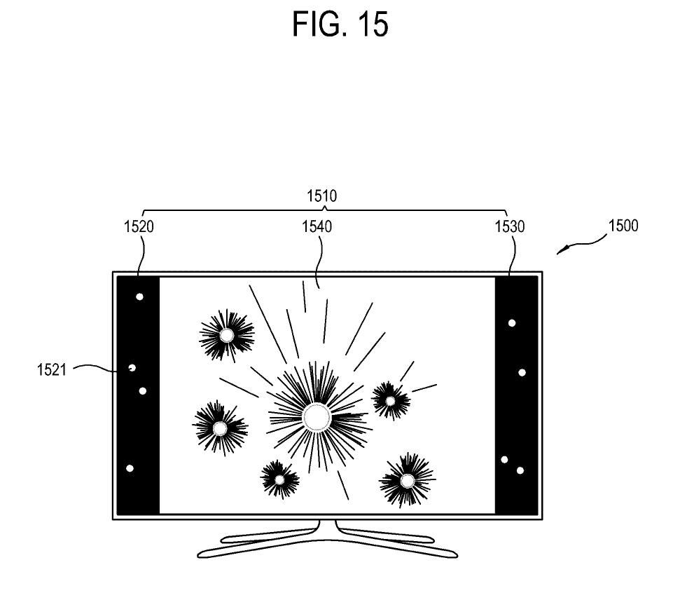

Referring to FIG. 15, the display apparatus 1500 displays a first image containing an object having a predetermined shape on a first area 1540. The display apparatus 1500 extracts the shape of the object from the first image displayed on the first area 1540, and selects the color of the object. The display apparatus 1500 senses the curvature of the display 1510, and displays a second image having image effects of the shape and color of the object, which are varied depending on the sensed curvature, on the second areas 1520 and 1530. For example, if the first image contains a plurality of objects each having a circular shape, a plurality of objects having circular shapes may be displayed as the second image, and a gradation may be applied to the shape of the object. As the curvature of the second areas 1520 and 1530 becomes higher, the number of objects may increase or the gradation may be rapidly applied.

In addition, the display apparatus 1500 may extract a resolution together with the shape of the object, and may change the resolution in accordance with the curvature of the second areas 1520 and 1530, thereby applying blurring to the shape of the object. Here, the display apparatus 1500 may increase the number of objects or apply strong blurring as the curvature of the second areas 1520 and 1530 becomes higher.

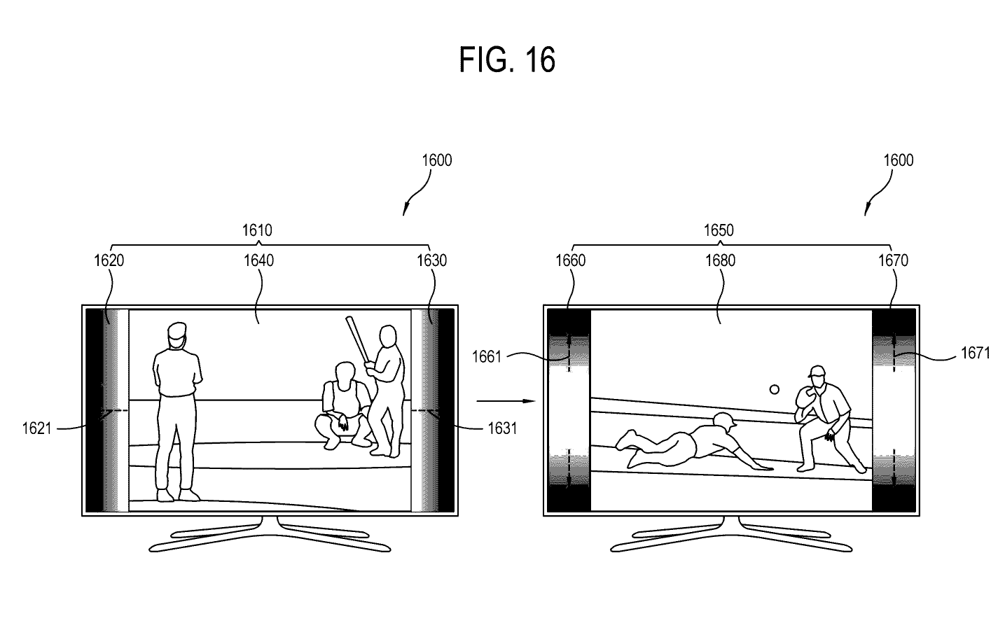

Referring to FIG. 16, the display apparatus 1600 extracts a motion of an object contained in a first image displayed on a first area 1640, and selects the color of the first image. The display apparatus 1600 may determine whether the motion of the object contained in the first area 1640 is equal to or higher than a predetermined value. If it is determined that the motion of the object is lower than the predetermined value, the color selected for displaying the gradations 1621 and 1631 on the left and right sides of the screen may be changed. At this time, the gradations 1621 and 1631 are rapidly displayed to thereby reinforce a static mood of the first image as the curvature of the second areas 1620 and 1630 becomes larger.

On the other hand, if it is determined that the motion of the object is equal to or higher than the predetermined value, vertically changing gradations 1661 and 1671 or radial gradations are displayed. At this time, the gradations 1661 and 1671 are rapidly displayed to thereby reinforce a dynamic mood of the first image as the curvature of the second areas 1620 and 1630 becomes larger.

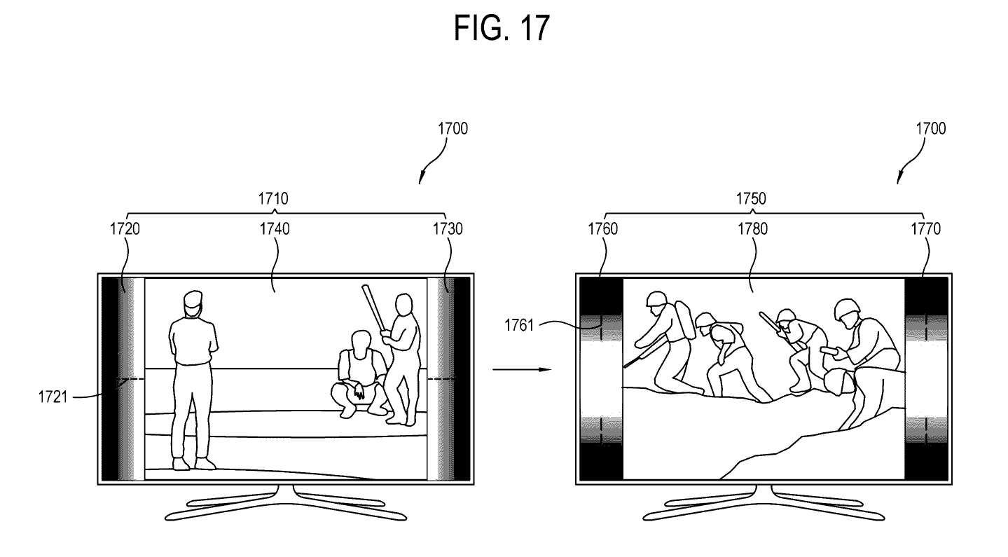

Referring to FIG. 17, the display apparatus 1700 may determine image effects for a second image to be displayed on second areas 1720 and 1730 in accordance with content of a first image displayed on a first area 1740. For example, if the first image displayed on the first area 1740 is related to entertainments or sports, the display apparatus 1700 displays a bright tone color tone on the second area in accordance with information about content of the first image. The display apparatus 1700 changes a color tone in accordance with the curvature of the second area, and displays a second image having image effects based on the changed color tone on the second areas 1720 and 1730.

On the other hand, if the first image displayed on a first area 1780 is related to war or horror movies, a dark tone color is used in the second area. The display apparatus 1700 changes the color tone in accordance with the curvature of the second area, and displays the second image having the image effect based on the changed color tone on the second areas 1760 and 1770.

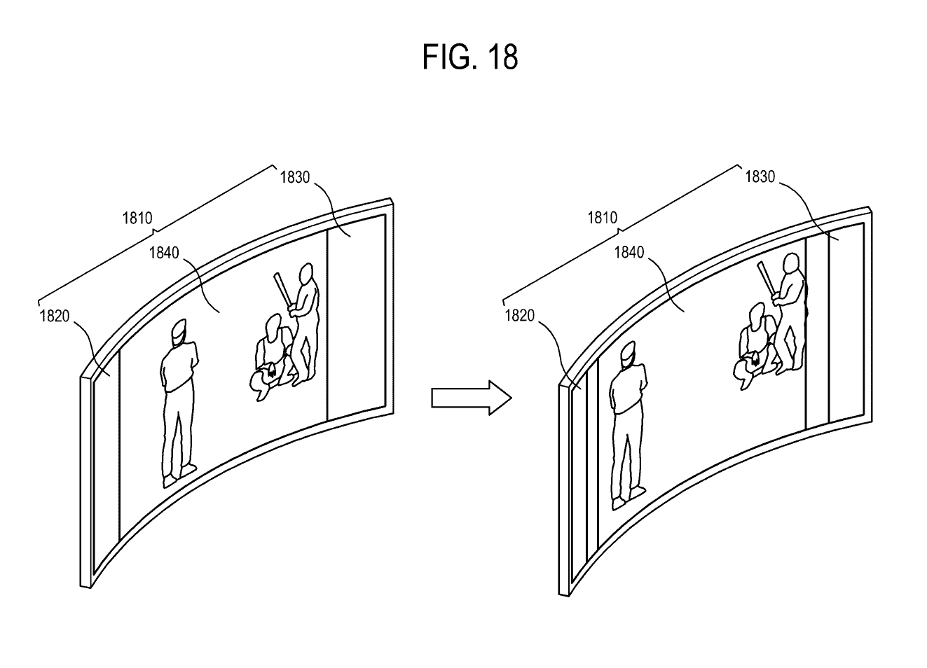

Referring to FIG. 18, the display apparatus 1800 is bent to have a predetermined bending angle or curvature in response to a user's input, and applies scaling to the first image in accordance with the predetermined bending angle or curvature, thereby displaying images on a first area 1840 and second areas 1820 and 1830. That is, the first image displayed on only the first area is extendable to the second areas 1820 and 1830 in accordance with the bending angle or curvature of the second areas 1820 and 1830, thereby making a user feel senses of extension, reality and immersion with respect to the first image.

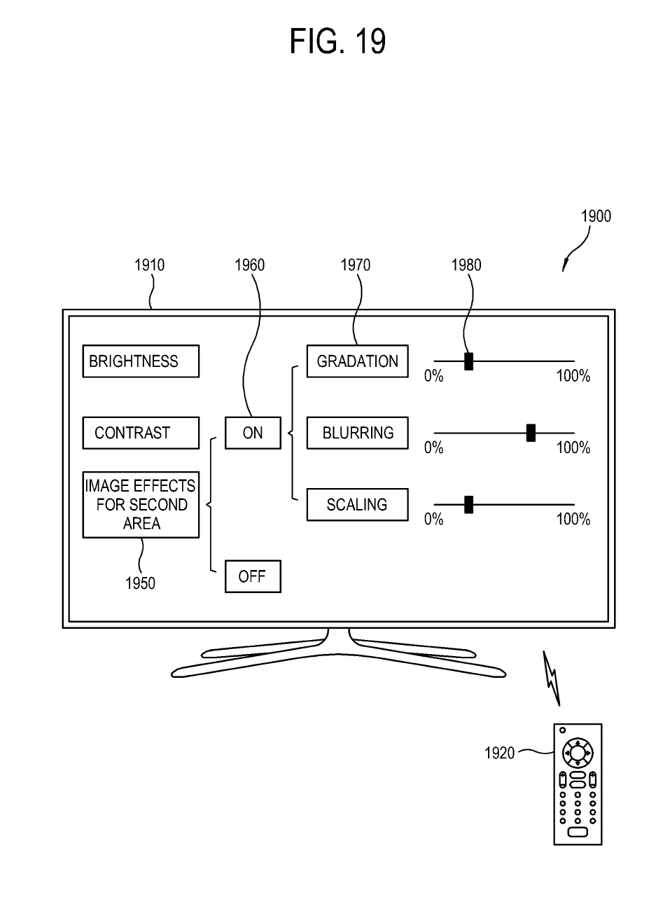

FIG. 19 is an example of the display apparatus 400 of FIG. 4. A display apparatus 1900 shown in FIG. 19 is equivalent to the display apparatus 400 of FIG. 4, and therefore repetitive descriptions will be avoided. The display apparatus 1900 may display a UI, which is for allowing a user to select whether to display a second image having image effects 1950 of attributes varied depending on a curvature of a second area on the second area, on a display 1910. To this end, the display apparatus 1900 may include a UI generator. If it is selected 1960 that the image effects are displayed on the second area in response to a user's input, the UI generator may display a UI for allowing a user to select the image effects such as a gradation, blurring and scaling on the display 1910.

Further, the UI generator may display a UI for allowing a user to adjust an applicable level of image effects in response to a user's input for selecting at least one of the image effects. For example, if a gradation 1970 is selected as the image effects, the UI generator may display a UI 1980 for adjusting the applicable level of at least one of a color, brightness, and color tone. However, the kind of image effects for the second image to be displayed on the second area is not limited to the foregoing gradation, blurring and scaling. Since a remote controller 1920 provided separately from the display apparatus 1900 may have arrow keys for moving on the UI displayed on the display 1910 and an OK key for selecting the UI, a user may use the remote controller 1920 to control the UI displayed on the display 1910.

According to an exemplary embodiment, there are provided a display apparatus, which is improved in displaying a second image to be displayed on a second area where a first image different in an aspect ratio from a display is not displayed, and a control method thereof, thereby increasing reality and immersion in the first image.

Although a few exemplary embodiments have been shown and described, it will be appreciated by those skilled in the art that changes may be made in these exemplary embodiments without departing from the principles and spirit of the invention, the scope of which is defined in the appended claims and their equivalents.

What is claimed is:

1. A display apparatus comprising:
a display configured to include a screen flexible to have a predetermined curvature;
a receiver configured to receive an image signal;
a signal processor configured to process the received image signal; and
a controller configured to, if the image signal has an aspect ratio different from a ratio of width to height of the screen, control the display to display a first image based on the image signal on a first area of the screen and a second image having image effects of attributes varied depending on a curvature of a second area on the second area around the first area.

2. The display apparatus according to claim 1, wherein the second image comprises an image which is displayed reflecting at least one of a color, brightness, contrast, a tone and a scale ratio of the first image.

3. The display apparatus according to claim 1, wherein the image effects comprise at least one of a gradation, blurring and scaling.

4. The display apparatus according to claim 3, wherein the gradation comprises a gradation of a color selected among a plurality of colors contained in the first image.

5. The display apparatus according to claim 4, wherein the color is selected from a part of the first area adjacent to the second area.

6. The display apparatus according to claim 4, wherein the color is selected from each of a plurality of parts of the first image, and
the image effects are differently applied in accordance with use frequencies of the plurality of selected colors.

7. The display apparatus according to claim 1, wherein the first image comprises a repetitive pattern, and
the image effects correspond to the pattern of the first image.

8. The display apparatus according to claim 7, wherein the pattern of the first image has an orientation, and
the image effects are oriented corresponding to the orientation of the first image.

9. A method of controlling a display apparatus comprising a display having a screen flexible to have a predetermined curvature, the method comprising:
receiving an image signal;
processing the received image signal; and
if the received image signal has an aspect ratio different from a ratio of width to height of the screen, displaying a first image based on the image signal on a first area of the screen and displaying a second image having image effects of attributes varied depending on a curvature of a second area on the second area around the first area.

10. The method according to claim 9, wherein the second image comprises an image which is displayed reflecting at least one of a color, brightness, contrast, a tone and a scale ratio of the first image.

11. The method according to claim 9, wherein the image effects comprise at least one of a gradation, blurring and scaling.

12. The method according to claim 11, wherein the gradation comprises a gradation of a color selected among a plurality of colors contained in the first image.

13. The method according to claim 12, wherein the color is selected from a part of the first area adjacent to the second area.

14. The method according to claim 12, wherein the color is selected from each of a plurality of parts of the first image, and
the image effects are differently applied in accordance with use frequencies of the plurality of selected colors.

15. The method according to claim 9, wherein the first image comprises a repetitive pattern, and
the image effects correspond to the pattern of the first image.

16. The method according to claim 15, wherein the pattern of the first image has an orientation, and
the image effects are oriented corresponding to the orientation of the first image.
